(19) United States
(12) Patent Application Publication
(10) Pub. No.: US 2013/0345061 A1
(43) Pub. Date: Dec. 26, 2013

(54) VEGETABLE OIL-BASED OIL-IN-WATER OR WATER-IN-OIL EMULSION AS PHYTOPHARMACEUTICAL ADJUVANT

(71) Applicants: Roman Gerusz, Peronnas (FR); Antoine Vanlaer, Paris (FR)

(72) Inventors: Roman Gerusz, Peronnas (FR); Antoine Vanlaer, Paris (FR)

(73) Assignee: MAXEL INDUSTRIES, Verberie (FR)

(21) Appl. No.: 13/984,352

(22) PCT Filed: Feb. 9, 2012
(86) PCT No.: PCT/FR2012/050281

§ 371 Date: Sep. 10, 2013

(30) Foreign Application Priority Data
Feb. 10, 2011 (FR) 11 51096

(51) Int. Cl. A01N 25/04

(52) U.S. Cl. CPC A01N 25/04
USPC 504/363; 514/770; 514/494; 424/705; 424/637; 424/641

(57) ABSTRACT

A water-in-oil (w/o) or oil-in-water (o/w) emulsion composed of an oily phase including one or more oils of crude or refined vegetable origin, and at least one non-ionic and/or anionic emulsifying surfactant, and of an aqueous phase, the aqueous phase including at least one phyllosilicate, as a phytopharmaceutical adjuvant intended to be mixed with at least one phytopharmaceutical active agent or as a phytopharmaceutical product with mechanical action. A phytopharmaceutical composition including an active agent and also a phytopharmaceutical adjuvant as defined above, and a method of treating plants with the composition.

### FIELD OF INVENTION

The present invention relates to the use of a water-in-oil or oil-in-water emulsion as a phytopharmaceutical product with mechanical action or as a phytopharmaceutical adjuvant.

The present invention also relates to a phytopharmaceutical composition comprising the abovementioned adjuvant.

The present invention also relates to the use of the phytopharmaceutical composition for protecting plants or plant products against all harmful organisms (insects, fungi, etc.) or preventing the action thereof.

### BACKGROUND OF THE INVENTION

Plants are continuously subjected to attacks by harmful organisms against which they possess self-defense means: cuticular barrier, production of bactericidal, fungicidal, virucidal molecules in response to a pathogenic attack.

However, the development of bulk crops, intensive irrigation, the excessive and imbalanced introduction of synthetic fertilizer and growing under plastic greenhouses have strongly promoted the proliferation of pathogens and pests.

In order to protect plants, the farmer intervenes directly on the pathogens or pests by using phytopharmaceutical products, also commonly referred to as pesticides.

Phytopharmaceutical products are defined by Directive 91/414/EEC as preparations containing one or more active substances and which are intended to protect plants and fruits thereof against all harmful organisms or prevent the actions of such organisms.

In practice, the mode of preparation and of application by spraying of these pharmaceutical products results in high losses, and consequently in soil and water pollution. It is considered that, on average, 20% of the losses are due to poor preparation and application conditions, 25% are due to evaporation or to volatilization because of wind and washing off by rain, and 25 to 30% are lost because they are sprayed outside the intended targets (leaves, stem, fruits, etc.). In total, only 25% to 40% at most of active substances reach their targets.

In order to partly remedy these large losses, corrective additives for phytopharmaceutical formulae have been proposed, called: plant protection adjuvants.

Plant protection adjuvants are substances devoid of phytopharmaceutical activity, but they are capable of improving the technical qualities of plant protection active materials, in particular they improve the compatibility and stability of the emulsion or of the aqueous solution of the treatment product when they are added thereto as an extemporaneous mixture (in the tank).

The main plant protection adjuvants sold on the market are generally formulated from the following basic materials: a mineral oil or terpene alcohols, fatty alcohol sulfuric esters, sulfonated fatty acid esters, diethylene glycol abietate or alkoxylated triglycerides. It is especially mineral oils which are used as adjuvants. Terpene alcohols are pulmonary allergens and are thus used less and less. The oily adjuvants are generally formulated from paraffinic mineral oils to which emulsifying surfactants are added. These mineral oils have demonstrated their effectiveness as a plant protection adjuvant, but have drawbacks in terms of the handling thereof, and repeated contact with the skin causes irritations and inflammations; in addition, they are toxic and non-biodegradable (unfavorable carbon balance).

Document WO 1995 031898 describes concentrated pesticidal compositions which can be used in agriculture and which are intended to be emulsified with water just before use. In order to viscosify the final formula, siliceous derivatives, such as precipitated or fumed colloidal silicas, are added. As subsidiary thickener, mention is made of the products known to those skilled in the art, such as mineral derivatives, for instance silicates (attapulgite, bentonites), magnesium aluminosilicates, organic derivatives, such as cellulose-based products of the cellulose ether type (carboxymethyl cellulose, hydroxypropyl cellulose) or else polymers, for instance gum arabic or xanthan gum.

Also known from the prior art is document EP 2 181 820, which describes a water-in-oil (w/o) or oil-in-water (o/w) emulsion composed of an oily phase comprising one or more oils of vegetable and/or mineral and/or synthetic origin, and at least one nonionic and/or anionic emulsifying surfactant, and an aqueous phase comprising water. The aqueous phase comprises in particular at least one phyllosilicate of formula Na⁺_{0.7} [(Si₈Mg_{5.5}Li_{0.3})O₂₀(OH)₄]^{-0.7} so as to obtain a fluid emulsion which is stable over time. This emulsion is intended to be used as an agent for demolding and/or stripping formwork.

Document WO 2005/020685 describes talc-based pesticidal compositions which are in the form of slurries (thick suspensions). The purpose of the invention is to provide a novel phytopharmaceutical composition which avoids all or some of the abovementioned drawbacks.

To this effect, the invention relates to the use of a water-in-oil (w/o) or oil-in-water (o/w) emulsion composed of an oily phase comprising one or more oils of crude or refined vegetable origin, and at least one nonionic and/or anionic emulsifying surfactant, and an aqueous phase comprising water and at least one phyllosilicate, as a phytopharmaceutical product with mechanical action or as a phytopharmaceutical adjuvant intended to be combined with a phytopharmaceutical active agent.

### SUMMARY OF THE INVENTION

The subject of the present invention is also a phytopharmaceutical composition comprising at least one phytopharmaceutical active agent and at least one phytopharmaceutical adjuvant, characterized in that said at least one phytopharmaceutical adjuvant is composed of a water-in-oil (w/o) or oil-in-water (o/w) emulsion composed of an oily phase comprising one or more oils of crude or refined vegetable origin, and at least one nonionic and/or anionic emulsifying surfactant, and of an aqueous phase comprising water, characterized in that the aqueous phase comprises at least one phyllosilicate.

It has in fact been found, surprisingly, that the emulsion described above makes it possible alone (as phytopharmaceutical product), by virtue of its mechanical action, in the pure or diluted state, to prevent the appearance of harmful organisms, for example by enabling the suffocation of larvae. 3 liters of emulsion/hectare as a dilution with water in fact make it possible to treat acarids on fruit trees during winter. Unexpectedly, the emulsion according to the invention thus acts as a plant protection product via mechanical action. The term “mechanical action” is intended to mean that the emulsion creates a barrier between the harmful organism and the external environment preventing any contact with the air and therefore with atmospheric oxygen, or else the emulsion is capable of coating the harmful organisms and therefore of suffocating them or of blocking, for example, their respiratory pathways.

Combined with a conventional phytopharmaceutical active agent, i.e. when the emulsion is used as a phytopharmaceutical adjuvant, the emulsion according to the invention makes it possible not only to combine their effects, but also to effectively, nontoxically and biodegradably emulsify the phytopharmaceutical active agent. The emulsion according to the invention also facilitates the storage of the phytopharmaceutical composition over time.

For the rest of the description, the compounds which will be described below are suitable both for the invention of use as a phytopharmaceutical product with mechanical action or as a phytopharmaceutical adjuvant intended to be combined with a phytopharmaceutical active agent and for the invention of phytopharmaceutical composition.

The emulsion according to the present invention is of the oil-in-water (o/w) or water-in-oil (w/o) type and is preferably nonionic.

By definition, an emulsion is a mixture of two immiscible substances which can be emulsified according to various formulations and various production techniques. Each substance is called a phase. In an emulsion, the phase in microdroplet form is the discontinuous phase, while the phase which surrounds the microdroplets is called the continuous phase. Thus, a water-in-oil (w/o) emulsion is composed of an aqueous discontinuous phase dispersed in an oily continuous phase and, conversely, an oil-in-water (o/w) emulsion is composed of an oily discontinuous phase dispersed in an aqueous continuous phase.

The o/w or w/o emulsion according to the invention is, in addition, fluid at ambient temperature (20-25° C.) The Bingham plastic viscosity can range, for example, from 5 mPa·s to 50 mPa·s, preferably from 8 mPa·s to 30 mPa·s when the viscosity is measured with a Lamy TVe-05 apparatus with the MS DIN 53019 measurement system (NF EN ISO 3219) at a temperature of 23° C. between a speed of 3 (200 rpm) and 2 (100 rpm). Bingham modeling makes it possible in fact to characterize a product by its Bingham viscosity, which is that of the product set in motion in the shear range analyzed (in this case, between the speeds 3 and 2). Indeed, the advantage of this modeling is that of determining a viscosity value which is constant, in the gradient range analyzed, instead of having a multitude of apparent viscosities, and also the pressure to be exerted on the product in order to convey it in this gradient range.

The emulsion according to the present invention, as indicated above, comprises in its aqueous phase, in addition to the water, at least one phyllosilicate.

The term “phyllosilicates” is intended to mean minerals of the group of silicates, made up of particles of which the basic units are infinite two-dimensional sheets, hence the name lamellar silicates. These sheets or lamellae consist of the association of tetrahedral layers of oxygen comprising a silicon or magnesium atom at the center and of octahedral layers composed of oxygen and of hydroxide, most commonly comprising aluminum or magnesium atoms at the center. The two major phyllosilicate families are characterized by the type of successive stacks of these octahedral (O) and tetrahedral (T) layers:

i.) The family of 1:1 or T:O phyllosilicates,

ii.) The family of 1:2:1 or T:O:T phyllosilicates, with for example smectites or illites.

A phyllosilicate suitable for the present invention preferably belongs to the smectite family. The crystalline half-lattice forming the basis of the two-dimensional sheets of smectites consists of seven superimposed atomic layers. The term “half-lattice” is used because two sheets are taken into account to define the repeat unit in the direction. This half-lattice is divided up into a layer of octahedra between two layers of tetrahedra. It is also possible to divide it up into a median layer of metal oxide, between two layers of silicon. The linking of the half-lattices in the x and y directions forms a sheet. The distance between sheets, called interfoliar distance, varies according to the type of “compensating” cations, i.e. according to the isomorphic substitutions of the median layer of the half-lattice and to the geological nature of the extraction soil. These cations are most commonly of Li⁺, Na⁺, Ca²⁺, K⁺ and Mg⁺ type and Mg²⁺ they will place themselves in the sites which are the least sterically hindered and closest to the centers with a deficit.

Preferably, the phyllosilicate according to the invention belongs to the family of smectites of hectorite type.

A hectorite (elementary sheet) is in the form of a platelet or else of a disk with a lateral dimension of less than 1000 nm, preferably ranging from 10 nm to 800 nm and even more preferably having a lateral dimension ranging from 20 nm to 100 nm+/−5 nm.

A phyllosilicate suitable for the present invention may be, for example, pyrophyllites, montmorillonites, bentonites, lucentites or a phyllosilicate of general formula:

Na⁺_{0.7} [(Si₈Mg_{5.5}Li_{0.3})O₂₀(OH)₄]^{-0.7}.

Preferably, the phyllosilicate corresponds to the formula below: Na⁺_{0.7} [(Si₈Mg_{5.5}Li_{0.3})O₂₀(OH)₄]^{-0.7}. The ideal theoretical structure of this phyllosilicate would have a neutral charge with six divalent magnesium ions in the octahedral layer, producing a positive charge of twelve. However, in practice, some magnesium ions are replaced with lithium ions and some spaces remain empty, so as to give a composition corresponding to the formula above.

In the latter phyllosilicate, it is noted that all the tetrahedral sites are occupied by silicon atoms. Two octahedral sites out of three are occupied by a magnesium atom. The third site is occupied by a lithium atom having substituted for magnesium during the synthesis. The result of this substitution is a positive-charge deficit. In order to re-establish electroneutrality, a charge compensation is carried out by means of exchangeable cations (Na⁺), external to the sheet, located in the interfoliar space and which are hydrated during the dispersion of the powder in water.

Because of the existence of these exchangeable cations, on the one hand, each sheet bears a negative charge and, on the other hand, the particles have a certain cation-exchange capacity (C.E.C.). The C.E.C. is 95 meq per 100 g, the diameter of the sheet of the phyllosilicate of formula Na⁺_{0.7} [(Si₈Mg_{5.5}Li_{0.3})O₂₀(OH)₄]^{-0.7} is 250±50° A whose thickness is 10° A′ (0.92 nm), and its surface charge density is S=0.014 e⁻/° A2 (i.e. approximately 700 elementary charges per face).

Indeed, it has been found that the stabilizing efficiency of specific phyllosilicates is linked not only to their special chemical and crystallographic composition, but also to their negative overall ion polarity after dispersion in water. In particular, the stability is improved with a phyllosilicate exhibiting an electric charge insufficiency of 0.7, such as the phyllosilicate of formula [(Si₉Mg_{5.5}Li_{0.3})O₂₀(OH)₄]^{-0.7}. In order to control the quality of this type of specific phyllosilicate, it is preferable to obtain them by synthesis from pure and regular basic components. The sheets obtained by synthesis will preferably be ground so as to obtain a dry, pulverulent phyllosilicate product which is easy to store.

Furthermore, contrary to emulsions containing conventional organic thickeners such as xanthan, the stabilization of the emulsions according to the present invention is not affected by temperature variations.

The aqueous phase of the emulsion according to the invention advantageously comprises a hydrophilic adjuvant.

Likewise, it is in fact possible to add to the aqueous phase, and also at a low dose, of about from 0.001% to 2% by weight relative to the total weight of the emulsion, hydrophilic adjuvants, such as biocidal protection agents, dispersants, chelating agents, antioxidants, thickeners, preservatives (such as an isothiazolone derivative), etc., which are well known to those skilled in the art. The adjuvants used are preferably biodegradeable and liquid at ambient temperature (20° C.)

The oily phase of the emulsion according to the invention comprises, as indicated above, at least one oil of crude or refined vegetable origin and at least one emulsifying surfactant.

Preferentially, the vegetable oil of the w/o or o/w emulsion is chosen from: rapeseed oil, soybean oil, sunflower oil, olive oil, palm oil, groundnut oil, jojoba oil, coconut oil and jatropha oil, or a mixture thereof.

Advantageously, the nonionic and/or anionic emulsifying surfactant according to the invention is chosen from: a liquid at ambient temperature (in the region of 20-25° C.), which is biodegradable and vegetable-based, and a biosurfactant, or a mixture thereof.

In particular, the nonionic emulsifying surfactant is chosen from an ethoxylated fatty alcohol, an ester of fatty acids and polyols, a sorbitan ester, a polyethoxylated sorbitan ester, an ethoxylated castor oil, an alkoxylated fatty alcohol, an alkyl polyglucoside, and a polymeric surfactant, or a mixture thereof, and the anionic emulsifying surfactant is chosen from an alkali metal salt of fatty and resin-based acids, an alkylaryl sulfonate, an alkylsulfosuccinate, an alkyl sulfate, an alkyl ether sulfate, an amide ether sulfate, and a sulfonic dodecylbenzene derivative, or a mixture thereof.

The nonionic or anionic emulsifying surfactant can also be chosen from biosurfactants. In particular, soybean lecithins, egg lecithins, polysaccharide-protein surfactants, and exopolysaccharides (EPSs) such as xanthan, or mixtures thereof, are suitable for the present invention.

Preferably, the oily phase comprises at least one oleophilic adjuvant. It is in fact possible to add to the oily phase, at a low dose, for example of about from 0.001% to 2% by weight relative to the total weight of the emulsion, oleophilic adjuvants, such as antifoams, antifreezes, antioxidants, colored tracers, etc., which are well known to those skilled in the art.

Preferentially, relative to the total weight of the water-in-oil (w/o) or oil-in-water (o/w) emulsion, the oil(s) represent(s) 10% to 80% by weight, the emulsifying surfactant represents 0.5% to 20% by weight, the water represents 10% to 90% by weight and the phyllosilicate represents from 0.01% to 20% by weight. Even more advantageously, the vegetable oils represent 5% to 50% by weight and the emulsifying surfactant represents 0.5% to 20% by weight, relative to the total weight of the oil-in-water (o/w) emulsion.

When the phytopharmaceutical adjuvant is intended to be combined with a phytopharmaceutical active agent, this active agent is preferentially chosen from: an insecticide (pyrhethrin, cypermethrin, bifenthrin, an organophosphate such as chlorpyrifos), a fungicide (copper hydroxide, copper sulfate, wettable sulfur, zinc and manganese dithiocarbamate (mancozeb, morpholine, strobilurin), a herbicide (glyphosate, aminotriazole), a bactericide and a growth regulator (trinexapac-ethyl, ethephon, chlorocholine chloride, chlormequat, choline chloride, prohexadione, mepiquat, trinexapac-ethyl, tebuconazole, metconazole, chlorpropham, Mentha spicata oil, b-indolebutyric acid, alpha-naphthylacetamide, gibberellic acid), or a mixture thereof.

When the subject of the present invention is the phytopharmaceutical composition, said composition comprises water.

In particular, relative to the total weight of the phytopharmaceutical composition (including the water), said at least one phytopharmaceutical adjuvant represents 0.05% to 70% by weight and said phytopharmaceutical active agent represents 0.05% to 10% by weight and the water represents 20% to 99.9% by weight. The above percentages depend on the desired action and therefore on the use of a herbicide, fungicide or insecticide, but also on the type of crop and plants to be treated (for example, beetroot or banana) and are very variable depending on the cases envisioned.

Generally, the user (farmer) will spray from 0.5 liter to 20 liters (L) per hectare of phytopharmaceutical active product, 2 liters to 20 liters per hectare of pure emulsion according to the invention, it being possible for the whole to be diluted with 0% to 90% of water, depending on the type of application (manual sprays or aircraft spraying).

In order to obtain an emulsion as described above which is homogeneous, a suitable method for the present invention may be the following and may comprise the steps below:

(i) preparing the oily phase by mixing the compounds which are part of the oily phase, such as at least one or more oils of vegetable origin and a nonionic and/or anionic emulsifying surfactant,

(ii) preparing the aqueous phase by mixing the compounds which are part of the aqueous phase, such as at least water (preferably deionized or softened) and the phyllosilicate,

(iii) continuous or batchwise mixing of the oily phase and the aqueous phase in a dispersing/emulsifying device.

The term “dispersing or emulsifying device” is intended to mean a device which makes it possible to effectively mix, shear and emulsify the emulsions, so as to obtain emulsions with fine globules.

The method as described above makes it possible to obtain homogeneous and uniform emulsions continuously; however, it is also possible to prepare the emulsions according to the invention in batchwise mode (batchwise method).

The method for preparing the emulsions according to the invention also has the advantages of being simple and economical. This is because there is no need, for example, to carry out phase inversions which require heating the oil and water phases at a high temperature (in the region of 90° C.), and therefore to increase the manufacturing costs.

Consequently, the mixing of the phases is carried out at ambient temperature. There is no phase inversion.

Even more particularly, the mixing of the phases is carried out at around from 20 to 25° C.

As mentioned above, the phyllosilicate(s) may be conditioned beforehand in the form of a fluid sol or gel.

It is also possible to concentrate the emulsion according to the present invention. For this, it is sufficient:

(i) to dissolve the phyllosilicate in a minimum amount of water (preferably deionized or softened water) so as to form a fluid sol or gel,

(ii) to mix at least one or more oils of vegetable origin and a nonionic and/or anionic emulsifying surfactant of the oily phase,

(iii) to mix the mixture obtained in step (i) with that obtained in step (ii).

The vegetable oils suitable for the present invention are in particular: rapeseed oil, soybean oil, sunflower oil, olive oil, palm oil, groundnut oil, jojoba oil, coconut oil and jatropha oil, or a mixture thereof.

In particular, palm oil is preferred with rapeseed oil.

Advantageously, these oils are crude but purified. The term “purified” is intended to mean that these oils have been at least filtered beforehand.

Palm oil is a fatty oil obtained from the pulp and the kernels of the fruits of the palm tree, the most common of which is Elaeis guineensis. The extraction is carried out under hot conditions by various mechanical methods or by extraction with solvents of the hexane type. Because palm oil congeals at ambient temperature, the storage and packaging are carried out under hot conditions (45° C. to 60° C.). The crude palm oil obtained is then clarified by decanting and filtered. At this stage, it is sold under the name CPO (Crude Palm Oil). CPO has an orangey yellow color and its composition is rich in fatty acids (palmitic acid, stearic acid, oleic acid, linoleic acid), and in triglycerides, and it also contains carotenoids, vitamins and trace elements.

These CPO palm oils therefore have complex and very variable compositions according to the origin or selection of the palm trees, according to the growing site and mode and according to the mode of extraction in production. Whatever the origins and modes of extraction of the palm oils, these CPO oils are always characterized by their bright orangey yellow color and by their high melting point (35° C. to 40° C.); they therefore congeal at ordinary temperature (20° C.) and are not therefore usable as they are without prior and sustained heating.

For the food sector, these CPO palm oils are generally refined, bleached and sold under the name RBD (Refined, Bleached, Deodorized). RBD palm oils have a neutral color or are colorless, with no odor, but their melting point is still as high as that of CPOs (35° C. to 38° C.) When used in food, RBD palm oils are used either in solid form (for frying), or in the form of water-in-oil emulsions for preparing, for example, margarines.

Tests for preparing fluid emulsions of RBD palm oil of oil-in-water type were carried out at the Porim Research Institute in Kuala Lumpur in Malaysia in 1996 by Chow and Ho (cf. JAOCS, Vol. 73 No. 1-1996). These researchers demonstrated the difficulties in stabilizing this type of oil-in-water emulsion, and emphasized the importance of the variables due to the complex compositions of RBD palm oils.

The other components of the emulsion according to the invention have been presented in the summary section and consequently will not be further described.

An objective of the present invention also relates to the use of the phytopharmaceutical composition described above for treating plants against harmful organisms.

In order to provide a better understanding of the subject of the invention, on the one hand, a device capable of making it possible to obtain the emulsions according to the invention will be described and, on the other hand, examples of preparation of said emulsions will be described (examples 1 to 3). Finally, tests for effectiveness of said emulsion will be presented (examples 4 to 8). The descriptions which follow are given by way of purely illustrative and nonlimiting examples; the drawing of the emulsifying device is a diagrammatic drawing intended only to illustrate the principle of the apparatus used for preparing the examples of the emulsions according to the invention.

### BRIEF DESCRIPTION OF DRAWINGS

In the drawing:

FIG. 1 represents, in axial section, an emulsifying device which makes it possible to obtain the compositions according to the invention;

FIG. 2 is a partial and diagrammatic representation of the vanes of the rotor and of the stator, the interaction of which vanes makes it possible to obtain a high shear rate and, consequently, an emulsion which is sufficiently fine to come within the scope of the present invention; and

FIG. 3 corresponds to a plan which reproduces the experimental arrangement of the ILVO research station in Merelbeke in Belgium used in example 7.

### DETAILED DESCRIPTION OF THE INVENTION

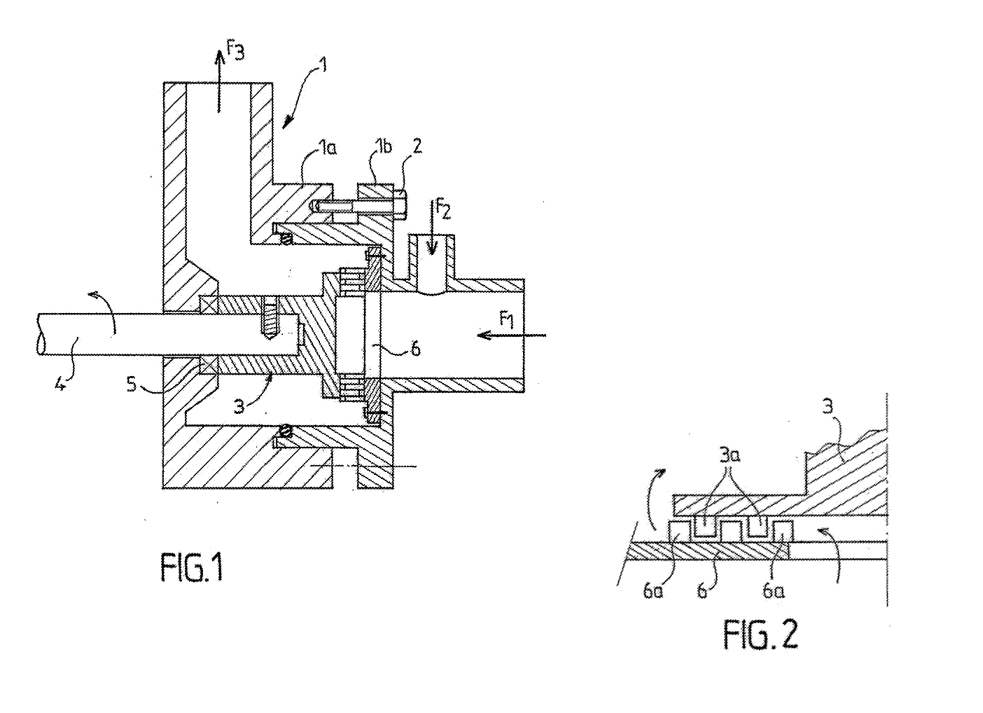

Although the emulsifying device represented in FIGS. 1 and 2 does not form part of the invention, a quick description of it will be given hereinafter. The designation 1 has been given to the stator of the emulsifier in its entirety. The stator 1 consists essentially of two parts 1a and 1b assembled together by means of bolts 2. The stator 1 receives a rotor, denoted by 3 in its entirety, the rotor 3 being driven rotationally with respect to the stator by a shaft 4. The rotation of the rotor 3 and of the shaft 4 with respect to the stator 1 is made possible by virtue of a system of leaktight bearings 5.

The part 1b of the stator comprises the inlet pipes for the products intended to form the emulsion: for example, the aqueous phase is conveyed along the arrow F1 and the oily phase of the emulsion is conveyed along the arrow F2 (or vice-versa). The combined mixture enters the stator, which comprises a circular blade holder 6 attached via screws to the part 1b of the stator, the blades 6a of the blade holder 6 being radial and directed toward the rotor 3, i.e. on the side opposite the arrival of the products to be emulsified. The end of the rotor 3 which is opposite the blade holder 6 has the form of a plate which carries the radial blades 3a. The blades 3a and 6a are positioned along concentric circles, the blades 3a being located in the circular annular spaces which exist between two successive circles of blades 6a.

The products to be emulsified enter the region between the blade holder 6 and the rotor 3 via a central circular orifice of the blade holder 6, centrifugally cross the space between the blade holder 6 and the rotor 3 and are ejected at the periphery of said space in order to be able to be discharged out of the device along the arrow F3. It is clear that the stream of incoming products is subjected to successive shearings between the stationary blades 6a and the blades 3a driven rotationally by the shaft 4. In a known manner, the fineness of the emulsion obtained depends, in particular, on the number of concentric circles of blades 3a and 6a, in the radial space between the edges of said blades and on the rotational speed of the shaft 4. In other words, for a given device and a given throughput, the characteristics of the emulsion obtained depend on the rotational speed of the rotor.

Preferably, a rotational speed of about 6500 revolutions/minute is suitable for obtaining fluid emulsions according to the present invention.

Examples of an emulsion according to the invention which are purely illustrative and nonlimiting with respect to the scope of the invention will now be described.

### EXAMPLE—1

### Emulsion Based on CPO Palm Oil

| Composition | % by weight |
|---|---|
| Oily phase | |
| CPO palm oil (vegetable oil) | 30.00 |
| ethoxylated fatty alcohols (emulsifying surfactant) | 5.50 |
| ethoxylated castor oil (emulsifying surfactant) | 2.50 |
| Aqueous phase | |
| deionized water | 61.16 |
| Na⁺_{0.7} [(Si₈Mg_{5.5}Li_{0.3})O₂₀(OH)₄]^{-0.7} | 0.80 |
| sodium benzoate (preservative) | 0.04 |
| Total | 100.00 |

### EXAMPLE—2

### Emulsion Based on RBD Palm Oil

| Composition | % by weight |
|---|---|
| Oily phase | |
| RBD palm oil (vegetable oil) | 30.00 |
| polyethylenated fatty acid esters | 6.00 |
| ethoxylated castor oil | 1.50 |
| Aqueous phase | |
| deionized water | 61.66 |
| Na⁺_{0.7} [(Si₈Mg_{5.5}Li_{0.3})O₂₀(OH)₄]^{-0.7} | 0.80 |
| isothiazolone derivative (preservative) | 0.04 |
| Total | 100.00 |

### EXAMPLE—3

### Emulsion Based on Purified Crude Rapeseed Oil

| Composition | % by weight |
|---|---|
| Oily phase | |
| rapeseed oil (vegetable oil) | 34.98 |
| fatty acid esters | 5.5 |
| castor oil | 2.5 |
| Aqueous phase | |
| deionized water | 56.38 |
| Na⁺_{0.7} [(Si₈Mg_{5.5}Li_{0.3})O₂₀(OH)₄]^{-0.7} | 0.6 |
| isothiazolone derivative | 0.04 |
| Total | 100.00 |

### EXAMPLE—4

### Prior Tests of Compatibility of the Above Emulsions (Examples 1 to 3) with Phytopharmaceutical Active Substances

Various phytopharmaceutical active substances were tested in order to know whether they were compatible with the emulsions according to the present invention.

These active substances are the following:

| Approved active substances | Approved active substances |
|---|---|
| BA (Biological Agriculture) | only conventional agriculture |
| wettable sulfur | mancozeb |
| (Microthiol Special | |
| Disperss - Cerexagri) | |
| Bordeaux mixture (RSR | |
| 20% Copper - Cerexagri) | |
| zinc sulfate | |

For this, the emulsions of examples 1 to 3 were prepared according to the abovementioned method. 1 L of each of the emulsions was then diluted with 0.25 L of water (¼ volume of additional water). 1% of each active substance above (percentage by weight, relative to the total weight of the diluted emulsion) was then mixed with each of the diluted emulsions.

In all the examples prepared, a homogeneous mixture stable for at least 24 hours was obtained.

### EXAMPLE—5

### Test of Effectiveness in Arboriculture (Small and Large Fruits) and Comparative Test with Prior Art Phytopharmaceutical Products (All the Tests were Carried out Confidentially)

The objectives targeted with this test are to prevent the development, namely the primary contamination of scab on apple trees and pear trees, and to also prevent peach leaf curl or currant leaf curl.

The comparative test was carried out with an all-crop insecticidal white oil (817 g/l of mineral oils) recommended in the winter and spring treatment of fruit trees and in the annual control of citrus scale insects. This white oil is sold under the brand Acakill® by the company C.C.L.

Test A: Treatment of Currant Bushes over a Period of Two Months (March and April 2010) During Bud Phenological Stage A and B

For this test, the emulsion of example 1 was used (30% of palm oil). 1 L of this emulsion was then diluted with 0.25 L of water (¼ volume of added water). For this test A, the emulsion according to the invention is used alone as phytopharmaceutical product with mechanical action (namely in order to suffocate and to prevent the growth of latent parasites), i.e. without additional phytopharmaceutical active agent.

1 L of prior art white oil was also diluted with 0.25 L of additional water (¼ volume of added water).

A row A of currant bushes was treated with the emulsion according to the invention, a row B was treated with the prior art white oil and a row C was not treated at all. The products were applied by spraying.

After two months (in May), it was observed on the current bush row C (control) that some leaves were curled and swollen, whereas, for the row A treated with the emulsion according to the invention and the row B treated with a prior art product, no curled or swollen leaf was observed.

Consequently, the emulsion according to the invention is just as effective as a prior art product as phytopharmaceutical product with mechanical action (asphyxia of larvae, of aphids), and in particular for treating currant leaf curl.

Test B: Treatment Every 15 Days of Apple Trees, Pear Trees and Peach Trees over a Period of 3 Months (April to June 2010) During Phenological Stage E2 to F2 (Outside Flowering)

For this test B, the emulsion according to the invention was used as phytopharmaceutical adjuvant. 1 L of solution of example 2 was used (30% of palm oil) and was diluted with 30 L of water and 100 grams of wettable sulfur (product according to the invention).

1 L of white oil (80% of oil) according to the prior art was also diluted with 30 L of water and 100 grams of wettable sulfur (comparative product) by way of comparison.

For each product (according to the invention and for the comparative product), a row of apple trees, pear trees and peach trees was treated by spraying. Furthermore, a row of these fruit trees was not treated, as a control row.

After three months (in July), scabbed leaves (exhibiting dark marks) and attacked fruit (marks in relief), were observed on the control pear trees and apple trees, whereas, for the rows treated with the product according to the invention or according to the prior art, virtually no scabbed leaves or attacked fruit were observed. With regard to the rows of peach trees, for the untreated control row, the presence of numerous curled leaves was noted, whereas the rows treated with the product according to the invention or the product according to the prior art (comparative) do not show curled leaves.

Consequently, an emulsion based on vegetable oils such as palm oil (30% of oil) can replace a white oil (80% paraffinic oil) in plant protection adjuvant application.

### EXAMPLE 6

### Test of Effectiveness in Preventive Plant Protection Treatment of Banana Plantations and Comparative Test (All the Tests were Carried out Confidentially)

The objectives targeted with this test are to prevent the development of the yellow sigatoka fungus (Mycosphaerella musicola) and to prevent the development of black sigatoka (Mycosphaerella fijiensis).

The comparative test was carried out using a white oil (WO) of Banole HV® type (paraffinic mineral oil: 825 gr/liter, i.e. approximately 80% of oil) sold by the company Total. 11 L of this white oil were diluted with 4 L of water, 0.1 L of an emulsifier: polyethylene glycol 4-tert-octyl phenyl ether (Triton X45® from Dow), and 0.4 L of pure fungicide (mancozeb) so as to obtain 15.5 liters of a solution according to the prior art (the preparation and the dosage of the white oil correspond to what is commonly used). This composition is intended to be sprayed at 15.5 L/hectare.

The phytopharmaceutical composition according to the invention was prepared from: 4 L of emulsion according to example 1 (30% of oil) which were diluted with 11.1 L of water and 0.4 L of pure fungicide (mancozeb) so as to obtain 15.5 liters of a phytopharmaceutical composition. This composition is also intended to be spread at 15.5 L/hectare.

These tests were carried out on a private banana plantation from Dec. 15, 2009 to the end of May 2010. 10 hectares were treated by aircraft spraying for each product: composition according to the invention and prior art composition (comparative example). In all, each of the 10 hectares treated were sprayed 10 times.

The observation consisted in looking at the possible development of marks due to the presence of yellow and/or black sigatoka fungi.

After four sprays, good results were noted with the phytopharmaceutical composition according to the invention, which are practically identical to the control region treated with the prior art composition.

After eight sprays, the hectares treated with the composition according to the invention appear to be better compared with the hectares treated with the prior art composition.

After ten sprays, the protection of the hectares treated with the composition according to the invention appears to be better compared with that of the hectares treated with the prior art composition.

Furthermore, it is considered that the productivity (volume and number of bananas per system) appears to be better on the region treated with the composition according to the invention compared with the control region treated according to the prior art; this probably being due to the non-toxicity and to the biodegradability of the emulsion according to the invention. A publication from Scienta Horticulturae, Vol. 56, issue 2, December 93, p. 107-117, by Jordan Valley Banana Research Station, has already shown that a high level of mineral oil reduced the growth rate of bananas, their flowering was delayed by four days and the bunch of bananas lost 5.6% by weight during the first year of production and 8.4% during the second year of production, compared with an untreated control sample.

### EXAMPLE 7

### Test of Effectiveness of the Emulsion According to the Invention as Phytopharmaceutical Adjuvant for Preventive Treatment by Foliar Spraying on a Leek Crop out of Doors After Artificial Inoculation of Pseudomonas syringae pv. porri

The objective of this experiment is to evaluate the ability of an emulsion according to the invention to increase the effectiveness of copper sulfate (active substance) sprayed preventively against “bacterial blight” of leek caused by Pseudomonas syringae pv porri.

The choice of the species treated is determining in so far as the leek leaf is particularly “waxy”, which very greatly limits the adhesion of the products on this type of foliage.

Leeks are planted out in the field in a test plot. They are treated preventively by foliar spraying with the various modes (see below) and then inoculated with a bacterial suspension of Pseudomonas syringae pv porri. A reading is carried out after 8 weeks of growing in the field by observing the symptoms of the disease on the leaves.

Experimental Arrangement and Observations

Products:

The emulsion according to the invention has the following composition:

| Composition | % by weight |
|---|---|
| Oily phase | |
| rapeseed oil (vegetable oil) | 26.985 |
| mixture of ethoxylated rapeseed | 4.6 |
| oil and ethoxylated castor oil | |
| Aqueous phase | |
| deionized water | 65.25 |
| glycerol | 2.00 |
| Na⁺_{0.7} [(Si₈Mg_{5.5}Li_{0.3})O₂₀(OH)₄]^{-0.7} | 0.95 |
| isothiazolone derivative | 0.2 |
| mixture of tocopherols (antioxidant) | 0.015 |
| Total | 100.00 |

The copper sulfate, and also the Phyton® 27 product (active material comprising 21% of copper sulfate pentahydrate and 5.5% of copper metal) are provided by ILVO (Institute for Research in Agriculture and Fisheries in Belgium).

The plant material is Allium porrum cv. Harston. It is at the stage of a young plant to be planted out and is healthy.

The Pseudomonas syringae pv porri strain is GBBC 988, isolated in 2011 from small leek seedlings produced in Morocco (Agadir).

The variability factors are the following:

Mode 1 (M1) is the negative control: the plants are treated with water.

Mode 2 (M2) corresponds to the plants treated with copper sulfate diluted in water (also called treatment mixture). The dosage is the following: 600 g of copper sulfate for 100 L of water (i.e. a copper sulfate concentrate of 6 g/L).

Modes 5 (M5), 6 (M6) and 7 (M7) are equivalent to mode 2 (6 g of copper sulfate per liter of mixture) to which has been added an increasing dose of the emulsion according to the invention (respectively 2.5 mL (0.25%), 0.5 mL (0.5%) and 10 mL (1%) for 1 L of treatment mixture). The emulsion was obtained according to the composition of the table above.

Mode 8 (M8) corresponds to a positive control which was treated with Phyton® 27 so as to obtain a mixture comprising 0.12% of Phyton® 27 (i.e. the treatment mixture comprises 1.2 mL of Phyton® 27 for 1 L).

The modes 3 and 4 initially planned were not applied because all these tests underwent natural washing off by rain.

The test thus comprises in total six modes, including controls (modes 1 and 8). Each mode was repeated twice in a complete random block arrangement.

Description of the Experimental Units:

Each experimental unit consists of 12 plants (3 rows of 4 plants).

The bacterial inoculation is carried out out of doors with a suspension of Pseudomonas syringae pv porri containing 10⁹ cells per liter. The suspension was nebulized under pressure (8 bar) at a rate of 100 ml per experimental unit.

Location of the Test

The test was carried out in the experimental plots of the ILVO research station at Merelbeke in Belgium.

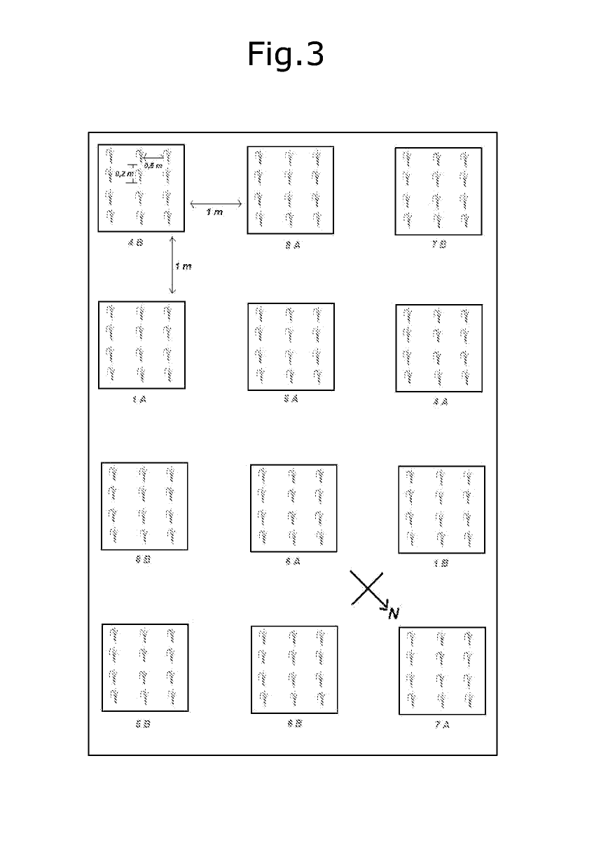

The plan represented in FIG. 3 reproduces the experimental arrangement in the field and represents the plans treated according to the various modes.

Setting Up and Implementation of the Test:

Sep. 14, 2011=day D:
Planting out of the leek plants according to the arrangement of the plan.

Sep. 21, 2011=day D+7:
Preventive treatment of the plants according to the various modes. The treatments are carried out with a hand spray until saturation of the foliage (formation of drops and running at the bottom of the leaves).

From Sep. 21, 2011 to September 27=7 days:
Watering of the plants=natural washing off by 15 mm of water (3×5 mm).

Sep. 28, 2011=day d+14:
Inoculation of the plants with a portable nebulizer.

From September 28 to Nov. 24, 2011=57 days:
Development of the bacterial infection.

Nov. 24, 2011=day d+71
Harvest.
Reading of the test.

A statistical analysis according to the Turkey test was also carried out in order to evaluate the presence or absence of significant differences between the percentage infection obtained according to the various modes.

Results of the Test

| | | | | Total | | |
|---|---|---|---|---|---|---|
| | | | Total | number of | | |
| | | | number of | positive | | |
| | | | leaves | leaves | | |
| | | Wetting | per | per | % | Significant |
| Mode | Product | agent | object | object | infection | difference |
| M1A | Water | 0 | 62 | 37 | 60 | a |
| M1B | | | 56 | 31 | 55 | a |
| 2 | | | | | | |
| 3 | | | | | | |
| M4A | CuSO₄ | 0 | 56 | 29 | 52 | b |
| M4B | | | 59 | 29 | 49 | b |
| M5A | CuSO₄ | 0.25% | 51 | 18 | 35 | b |
| M5B | | | 46 | 17 | 37 | b |
| M6A | CuSO₄ | 0.50% | 54 | 17 | 31 | c |
| M6B | | | 51 | 16 | 31 | c |
| M7A | CuSO₄ | 1.00% | 51 | 13 | 25 | c |
| M7B | | | 55 | 15 | 27 | c |
| M8A | Phyton | 0 | 55 | 10 | 18 | c |
| M8B | | | 52 | 11 | 21 | c |

The objective of the test was to evaluate the ability of a wetting agent based on rapeseed oil to increase the effectiveness of a Bordeaux mixture applied preventively against “bacterial blight” on leeks.

The results obtained from the positive and negative controls make it possible to validate the test.

Indeed, it is observed that mode 1 has more than 57% of leaves attacked. On the other hand, the application of the positive control product (mode 8) shows only 20% of leaves attacked.

Mode 4, achieving a high level of infection of more than 50%, attempts to demonstrate that copper sulfate without wetting agent has only a slight effect.

On the other hand, modes 5, 6 and 7 express a gradient of protection which rises with respect to the concentration of the wetting agent. There is a step of +5% of uninfected leaves between each concentration.

In summary, the significant differences between the modes are the following (statistical test): M1 M4 M5 M6 M7 M8=“a” “ab” “bc” “c” “c” “c”. Thus, there is no significant difference between modes M6, M7 and M8: copper sulfate with the wetting agent at 0.5% or 1% is shown to be equivalent to the reference product (Phyton® 27).

In conclusion, it is observed that the addition of wetting agent provides, under the conditions of this test, a better protection against bacterial blight on leeks. It is observed that the dosage of the product revealed, in this case, significant differences between 0.25%, 0.5% and 1%, showing an increased protection for doses of 0.5% and of 1.0%.

### EXAMPLE 8

### Evaluation of the Ability of the Emulsion According to the Invention as a Phytopharmaceutical Adjuvant to Increase the Effectiveness of Fungicidal Protection in the Presence of Washing Off by Rain in the Context of Controlling Potato Blight

The objective of this experiment is to evaluate the ability of a wetting agent to increase the effectiveness of fungicidal protection in the presence of washing off by rain in the context of controlling potato blight, Phytophthora infestans.

Minitubers resulting from hydroponic culture are matured in a conditioned chamber for six weeks. After this period, the plants are treated according to the various modes (see below). Mode 8 was added to the experimental arrangement in order to evaluate the effectiveness of the fungicide in the absence of rain.

In order to evaluate the effectiveness of the various modes in controlling blight, the leaves are removed from the treated plants, inoculated in the laboratory using a suspension of sporangia of known concentration and incubated; the capacity of the sporangia to produce sporulating necroses constituting the effectiveness indicator.

Experimental Arrangement and Observations

Products:

The emulsion according to the invention has the following composition:

| Composition | % by weight |
|---|---|
| Oily phase | |
| rapeseed oil (vegetable oil) | 26.985 |
| mixture of ethoxylated rapeseed | 4.6 |
| oil and ethoxylated castor oil | |
| Aqueous phase | |
| deionized water | 65.25 |
| glycerol | 2.00 |
| Na⁺_{0.7} [(Si₈Mg_{5.5}Li_{0.3})O₂₀(OH)₄]^{-0.7} | 0.95 |
| isothiazolone derivative | 0.2 |
| mixture of tocopherols (antioxidant) | 0.015 |
| Total | 100.00 |

The phytopharmaceutical ingredient (fungicide) is Dithane® WG (Dow AgroSciences B.V.) comprising 75% of mancozeb as active material.

Potato: the Bintje variety was chosen for its high sensitivity to foliage blight. The starting plant material is healthy and is derived from minitubers originating from a hydroponic culture. The minitubers, pre-germinated beforehand, were planted in a vermiculite-based substrate at one minituber per pot. After 6 weeks of cultivation, the plants are treated according to the various modes. The plants are fertilized using a nutritive solution at a rate of twice a week.

The blight strain, Phytophthora infestans: is a strain collected in 2010 (reference: 10/044).

The washing off is rain corresponding to a precipitation of 20 mm. It is introduced onto the plants which have been treated over a period of 30 minutes.

Description of the Variability Factors

Mode 1 (M1) is a negative control: the plants are treated with water and do not undergo washing off.

Modes 2 (M2) and 3 (M3) correspond to the plants treated with the emulsion according to the invention at the dose of 1%, the first mode does not undergo washing off with rain, whereas the second is subjected to rain.

Mode 4 (M4) corresponds to the plants treated using the contact product at full dose (approved dose of Dithane®) and subjected to rain.

Modes 5 (M5), 6 (M6) and 7 (M7) are equivalent to mode 4 to which has been added an increasing dose of the emulsion according to the invention (respectively 0.25%, 0.5% and 1% of the treatment mixture); the plants are also subjected to washing off by rain.

Mode 8 was added to the experimental arrangement; it is equivalent to mode 4 without washing off and therefore corresponds to the positive control.

A survey of the various modes tested is given in the following table:

| Modes | Product | Dose | Product | Rain |
|---|---|---|---|---|
| 1 | Water | — | — | NO |
| 2 | Em. Inv* | 1.00% | — | NO |
| 3 | Em. Inv* | 1.00% | — | YES |
| 4 | — | | Mancozeb | YES |
| 5 | Em. Inv* | 0.25% | Mancozeb | YES |
| 6 | Em. Inv* | 0.50% | Mancozeb | YES |
| 7 | Em. Inv* | 1.00% | Mancozeb | YES |
| 8 | — | | Mancozeb | NO |

*Em. Inv = emulsion according to the invention

Description of the Experimental Units:

The experimental unit consists of a plant receiving the application of a treatment (see modes).

The observations intended to verify the effectiveness of the treatments for controlling potato blight are carried out on one complete 5-leaflet leaf per plant.

The inoculation is carried out on detached leaves; they are deposited in a closed incubation dish, the bottom of which is covered with moist blotting paper. Each of the leaflets is inoculated using a suspension of sporangia (concentration of 50 000 sporangia/ml) at a rate of 2 drops of 10 μl/leaflet (on either side of the midrib). The incubation dish containing the leaf is then placed in an incubator regulated at 16° C. and with a photoperiod of 16 h.

7 days after incubation, the leaves are observed. The symptoms (spots and sporulation) are noted according to the seriousness scale (see appendix 1).

The observations are carried out on a half-leaflet (5 gradings per leaf).

Location of the Test

The test was carried out at the Centre Wallon de Recherches Agronomiques [Walloon Center for Agronomic Research] CRA-W in the Haute-Belgique building.

Setting Up and Implementation of the Test

Week—6:
Preparation of the pots and installation of 15 pots per tray.
Filling of the pots with vermiculite.
Transplantation of the minitubers (press the compost well in order to ensure good adhesion of the plant to the substrate).
Maturing of the small seedlings in a climatic chamber (temperature: 20° C., photoperiod: 12 h/day-12 h/night).

Week—6 to week 0:
Watering and fertilization.
Staking and verification of plant vitality.

Day D:
Preparation of the material (pipette, tips, treatment products, distilled water, Falcon®, etc.).
Marking of the plants.
Preparation of the treatment solutions according to variability factors 1 to 8.
Treatment of the plants at a rate of 7.5 ml per plant using an airbrush.
Avoid contacts between plants having undergone different treatments.
Acclimatization of the plants in greenhouses.

Day D+1:
Simulation of 20 mm of rain over a period of 30 minutes. Natural drying of the plants.

Day D+3:
Preparation of the inoculum at 50 000 sporangia per ml.
Sampling of the leaves (5 leaflets) at a rate of one leaf per plant (upper leaf).
Placing of the leaves in an incubation dish (containing a moist napkin+20 ml of sterile distilled water+moist cotton wool at the level of the petiole).
Inoculation of the leaves at a rate of 2 drops of 10 μl per leaflet (see
Placing of the dishes in the incubator (temperature: 16° C., photoperiod: 16 h/day-8 h/night).

Day D+10:
Observation of the leaves and noting of the symptoms according to a seriousness scale (0 to 4) (see below). The observations are carried out per leaflet, i.e. 5 gradings per leaflet. Should the leaf exhibit symptoms of rot because of excess moisture in the incubation chamber, grading is not possible; a grade NC is indicated and is not therefore taken into account in the calculation of the mean.

Symptom Grading Scale and Statistical Study

Grade 0: no visible symptom on the leaflet.

Grade 1: the symptoms are exhibited in the form of a black spot or of black points at the site of the inoculum. This collection of points occupies a surface area corresponding to that of a drop of inoculum. No progression of the necroses beyond the point of inoculation is observed.

Grade 2: the symptoms are exhibited in the form of a black spot which is 0.5 to 1 cm in diameter. Its center corresponds to the site where the drop of inoculum was deposited. At the periphery of the spot, the necrosis has a nebulous appearance, the black coloration is less strong. No sporulation is visible to the naked eye.

Grade 3: the symptoms are exhibited in the form of a black spot which is 0.5 to 1 cm in diameter (idem grade 2) with, at the periphery, the presence of a slight mycelia felting (fruiting).

Grade 4: the symptoms are exhibited in the form of a spot of 1 to 3 cm. Abundant sporulation is present within and around the spot.

Grade NC: A grade cannot be assigned because of the development of leaf rot (high humidity conditions).

A statistical analysis according to the variance test was also carried out in order to evaluate the presence or absence of significant differences between the percentage infection obtained according to the various modes.

Results of the Test

| | | | | | | Grading | |
|---|---|---|---|---|---|---|---|
| Modes | Product | Dose | Product | Rain | Product | (average) | Stat measurement |
| M1 | Water | — | — | NO | Water | 4.00 | a |
| M2 | Em. | 1.00% | — | NO | Em. Inv | 4.00 | a |
| | Inv* | | | | | | |
| M3 | Em. | 1.00% | — | YES | Em. Inv | 4.00 | a |
| | Inv* | | | | | | |
| M4 | — | | Mancozeb | YES | — | 3.60 | a |
| M5 | Em. | 0.25% | Mancozeb | YES | Em. Inv | 1.75 | c |
| | Inv* | | | | | | |
| M6 | Em. | 0.50% | Mancozeb | YES | Em. Inv | 1.95 | c |
| | Inv* | | | | | | |
| M7 | Em. | 1.00% | Mancozeb | YES | Em. Inv | 2.35 | c |
| | Inv* | | | | | | |
| M8 | — | | Mancozeb | NO | — | 0.65 | d |

*Em. Inv = emulsion according to the invention

The objective of the test was to evaluate the ability of an oil-based wetting agent to increase the effectiveness of a contact fungicide in the presence of rain on the development of potato blight.

The results obtained from the positive and negative controls are in compliance: the treatment of the plants using Dithane (mancozeb-based fungicide, at full dose) controls blight infections when there is no rain (mode 8; grade: 0.65), but does not control the treated plants when rain washes off the fungicide (mode 4; grade: 3.60). The nonprotected plants (treatment with water and with oil) are covered with blight fruiting (modes 1, 2, 3 and 4; maximum grade of 4.00).

The treatment effectiveness tests carried out using the oil-based wetting agent in combination with a full dose of fungicide and subjected to rain show better effectiveness results compared with the fungicide applied alone. The modes in the presence of an increase in dose of wetting agent in combination with the fungicide and with washing off are 1.75, 1.95 and 2.35 compared with the fungicide alone (grade of 3.60).

A statistical analysis of the results of the test shows three groups: group 1 corresponds to mode 8, where there is almost complete control of the blight (statistical measurement d); group 3 (statistical measurement a), corresponds to modes 1, 2, 3 and 4 where the blight is not controlled; finally, group 2 (statistical measurement c) brings together the modes composed of fungicide in combination with the wetting agent and of which the control is significantly greater than the fungicide applied alone. However, an increasing dose of wetting agent in the treatment mixture does not lead to an increase in effectiveness. On the contrary, the dose of 1% of wetting agent gives a worse effectiveness result than the respective doses of 0.25% and 0.5%. In addition, certain repetitions (mode 5, mode 6, mode 7) do not show control, the blight sporulates on all the points of inoculation.

In summary, it appears that the addition of wetting agent to the treatment mixture provides a beneficial effect in the control of the blight in the case of rain and of use of a contact fungicide.

Although the invention has been described in relation to one particular embodiment, it is quite obvious that it is in no way limited thereto and that it comprises all the technical equivalents of the means described and also the combinations thereof if they fall within the scope of the invention.

1-9. (canceled)

10. A phytopharmaceutical composition comprising a phytopharmaceutical active agent and at least one phytopharmaceutical adjuvant, characterized in that said at least one phytopharmaceutical adjuvant is a water-in-oil (w/o) or oil-in-water (o/w) emulsion composed of an oily phase comprising one or more oils of crude or refined vegetable origin, and at least one nonionic and/or anionic emulsifying surfactant, and of an aqueous phase, characterized in that the aqueous phase comprises at least one phyllosilicate.

11. The phytopharmaceutical composition as claimed in claim 10, wherein the phytopharmaceutical active agent is chosen from: an insecticide, a fungicide, a herbicide, a bactericide and a growth regulator, or a mixture thereof.

12. The phytopharmaceutical composition as claimed in claim 10, wherein the phyllosilicate corresponds to the formula below:
Na⁺_{0.7} [(Si₈Mg_{5.5}Li_{0.3})O₂₀(OH)₄]^{-0.7}.

13. The phytopharmaceutical composition as claimed in claim 10, wherein the vegetable oil is chosen from: rapeseed oil, soybean oil, sunflower oil, olive oil, palm oil, groundnut oil, jojoba oil, coconut oil and jatropha oil, or a mixture thereof.

14. The phytopharmaceutical composition as claimed in claim 10, wherein the nonionic and/or anionic emulsifying surfactant is chosen from: a liquid at ambient temperature, which is biodegradable and vegetable-based, and a biosurfactant, or a mixture thereof.

15. The phytopharmaceutical composition as claimed in claim 14, wherein the nonionic emulsifying surfactant is chosen from an ethoxylated fatty alcohol, an ester of fatty acids and polyols, a sorbitan ester, a polyethoxylated sorbitan ester, an ethoxylated castor oil, an alkoxylated fatty alcohol, an alkyl polyglucoside, a polymeric surfactant, an alkali metal salt of fatty and resin-based acids, an alkylaryl sulfonate, an alkylsulfosuccinate, an alkyl sulfate, an alkyl ether sulfate, an amide ether sulfate, and a sulfonic dodecylbenzene derivative, soybean lecithins, egg lecithins, polysaccharide-protein surfactants, and exopolysaccharides (EPSs) or a mixture thereof.

16. The phytopharmaceutical composition as claimed in claim 10, also comprising water.

17. The phytopharmaceutical composition as claimed in claim 16, wherein, relative to the total weight of the phytopharmaceutical composition, said at least one phytopharmaceutical adjuvant represents 0.05% to 70% by weight and said phytopharmaceutical active agent represents 0.05% to 10% by weight and the water represents 20% to 99.9% by weight.

18. A method for treating plants against harmful organisms, comprising applying the phytopharmaceutical composition according to claim 10 to a plant in need thereof.

19. The method as claimed in claim 18, wherein the phytopharmaceutical active agent is chosen from: an insecticide, a fungicide, a herbicide, a bactericide and a growth regulator, or a mixture thereof.

20. The method as claimed in claim 18, wherein the phyllosilicate corresponds to the formula below:
Na⁺_{0.7} [(Si₈Mg_{5.5}Li_{0.3})O₂₀(OH)₄]^{-0.7}.

21. The method as claimed in claim 18, wherein the vegetable oil is chosen from: rapeseed oil, soybean oil, sunflower oil, olive oil, palm oil, groundnut oil, jojoba oil, coconut oil and jatropha oil, or a mixture thereof.

22. The method as claimed in claim 18, wherein the nonionic and/or anionic emulsifying surfactant is chosen from: a liquid at ambient temperature, which is biodegradable and vegetable-based, and a biosurfactant, or a mixture thereof.

23. The method as claimed in claim 22, wherein the nonionic emulsifying surfactant is chosen from an ethoxylated fatty alcohol, an ester of fatty acids and polyols, a sorbitan ester, a polyethoxylated sorbitan ester, an ethoxylated castor oil, an alkoxylated fatty alcohol, an alkyl polyglucoside, a polymeric surfactant, an alkali metal salt of fatty and resin-based acids, an alkylaryl sulfonate, an alkylsulfosuccinate, an alkyl sulfate, an alkyl ether sulfate, an amide ether sulfate, and a sulfonic dodecylbenzene derivative, soybean lecithins, egg lecithins, polysaccharide-protein surfactants, and exopolysaccharides (EPSs), or a mixture thereof.

24. The method as claimed in claim 18, wherein, relative to the total weight of the water-in-oil (w/o) or oil-in-water (o/w) emulsion, the oil(s) represent(s) 10% to 80% by weight, the emulsifying surfactant represents 0.5% to 20% by weight, the water represents 10% to 90% by weight and the phyllosilicate represents from 0.01% to 20% by weight.

25. The method as claimed in claim 18, wherein the oily phase comprises at least one oleophilic adjuvant.

26. The method as claimed in claim 18, wherein the aqueous phase comprises a hydrophilic adjuvant.
